(19) United States
(12) Patent Application Publication
(10) Pub. No.: US 2023/0006918 A1
(43) Pub. Date: Jan. 5, 2023

(54) AUTOMATIC LINK AGGREGATION FOR INCOMPATIBLE DATA PORTS ON A COMPUTER NETWORK

(71) Applicant: Fortinet, Inc., Sunnyvale, CA (US)

(72) Inventor: Sekhar Sumanth Gorajala Chandra, Fremont, CA (US)

(21) Appl. No.: 17/364,848

(22) Filed: Jun. 30, 2021

(51) Int. Cl. H04L 12/709; H04L 12/751; H04L 12/721; H04L 12/725

(52) U.S. Cl. CPC H04L 45/245; H04L 45/02; H04L 45/123; H04L 45/308

(57) ABSTRACT

An aggregate port selection is received from user to bundle at least two individual data ports of the network device for single channel data transfer. The lowest common denominators of physical capabilities (speed and duplex) of selected ports on the network device is determined through an operating system. Downgraded physical capabilities of at least one of the at least two data ports are committed to match lowest common denominators of the at least two data ports. Data exchanges are conducted over the at least two ports of the network device according to LACP.

### FIELD OF THE INVENTION

The invention relates generally to computer devices and computer networking, and more specifically, for automatically configuring link aggregation of incompatible data ports on a computer network.

### BACKGROUND

Link aggregation in computer networking is the combining of multiple network connections in parallel by any of several methods, and is also known as trunking, bundling, bonding, channeling or teaming, into a link aggregation group. These methods increase the throughput beyond what a single connection could sustain. Link aggregation also provides redundancy in case one of the links should fail.

When two devices are connected using the IEEE 802.3ad communication protocol and configure link aggregation on the ports, the ports need to be the same speed and duplexed. In order to achieve this, manual steps are needed to configure the ports on the switch. For example, to configure link aggregation between any two ports (1 port is 1G and the other is 2.5G) with different link speed capabilities, manual change is needed for the speed on the switch port to 1G to make the config work as expected. This is time consuming and not zero touch provisioning.

Therefore, what is needed is a robust technique for automatically configuring link aggregation of incompatible data ports network.

### SUMMARY

These shortcomings are addressed by the present disclosure of methods, computer program products, and systems for automatically configuring link aggregation of incompatible data ports.

In one embodiment, a data transfer between network devices is initiated. To do so, an aggregate port selection is received from user to bundle at least two individual data ports of the network device for single channel data transfer.

In another embodiment, the lowest common denominators of physical capabilities (speed and duplex) of selected ports on the network device is determined through an operating system. Downgraded physical capabilities of at least one of the at least two data ports are committed to match lowest common denominators of the at least two data ports. Data exchanges are conducted over the at least two ports of the network device according to LACP.

Advantageously, both network performance and computer hardware performance are improved with faster data transfer configuration.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level illustration of a system for automatically configuring link aggregation of incompatible data ports, according to an embodiment.

FIG. 2 is a more detailed illustration of a gateway device of the system of FIG. 1, according to an embodiment.

FIG. 3 is a more detailed illustration of a link aggregation module of FIG. 2, according to some embodiments.

FIG. 4 is a high-level flow diagram illustrating a method for data transfers using LACP, according to one preferred embodiment.

FIG. 5 is a more detailed flow diagram illustrating the step of automatically configuring link aggregation of incompatible data ports for the method of FIG. 4, according to one embodiment.

FIG. 6 is an example of a computing environment, according to an embodiment.

### DETAILED DESCRIPTION

The description below provides methods, computer program products, and systems for automatically configuring link aggregation of incompatible data ports. One of ordinary skill in the art will recognize many additional variations made possible by the succinct description of techniques below.

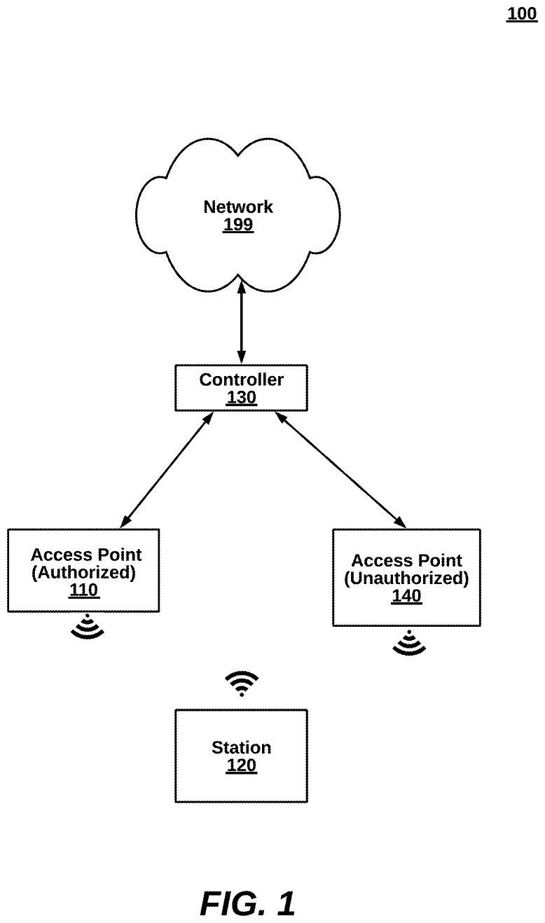

I. Systems for Automatic Link Aggregation for Incompatible Data Ports (FIGS. 1-3)

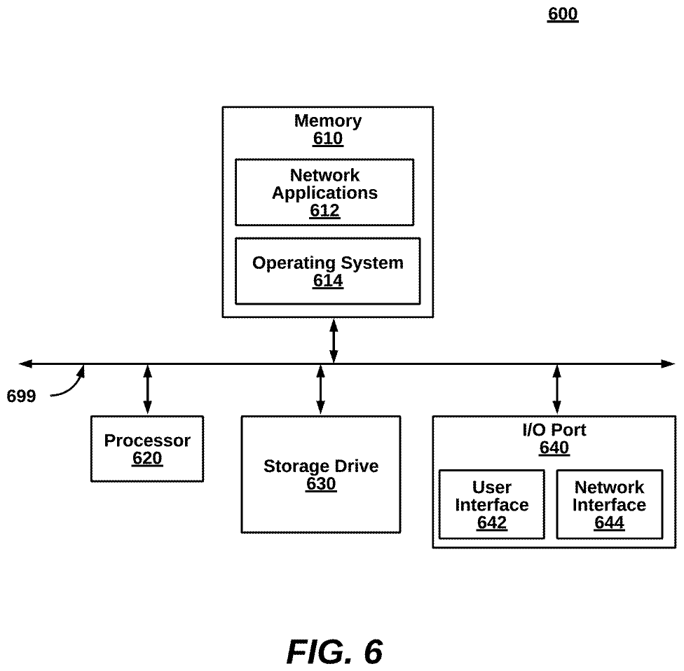

FIG. 1 is a high-level illustration of a system 100 for automatically configuring link aggregation of incompatible data ports, according to an embodiment. The system 100 includes, a gateway device 110, a switch 120, an access point 130 and a station 140. Many other embodiments are possible, for example, more or fewer access points, more or fewer stations, and additional components, such as firewalls, routers and switches. The system 100 components can be located locally on a LAN or include remote cloud-based devices, and can be implemented in hardware, software, or a combination similar to the example of FIG. 6.

The components of the system 100 are coupled in communication over a network 199. Preferably, the gateway device 110, the switch 120 and the access point 130 are connected to the data communication system via hard wire. Other components, such as the station 140 are connected indirectly via wireless connection. The network 199 can be a data communication network such as the Internet, a WAN, a LAN, WLAN, a cellular network (e.g., 3G, 4G, 5G or 6G), or a hybrid of different types of networks. Various data protocols can dictate format for the data packets.

Multiple parallel data lines are shown in FIG. 1. Data lines 101 represent a channel for digital data communication between the gateway device and the switch 120. In this instance there are 2 data lines. Data lines 102 have 4 data lines between the switch 120 and the access point 130. Communication hardware and software, such as transceivers, data encoders, data packetizers, and the like, enable functional operation of the data lines 101, 102 for higher layer applications exchanging the data.

In one embodiment, the gateway device 110 automatically configures data ports with the switch 120. First, the network device 110 detects link aggregation is being selected between two ports, for example, when two ports are added to the members of link aggregation config. The link speed and duplex capabilities of the two ports are determined. In response, the network device 110 makes necessary changes to the configuration in the backend, such as configuring the ports to the same speed and duplex to support successful operation by committing the necessary changes.

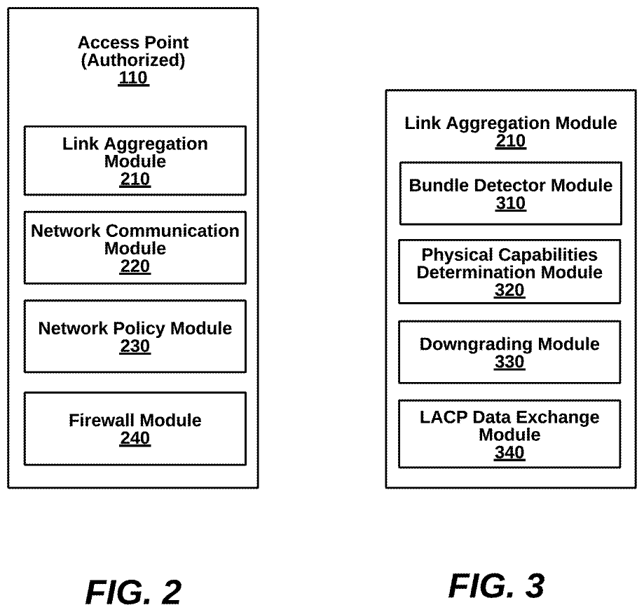

In other operations, the gateway device 110 can perform firewall duties to protect an enterprise network from external and internal threats (e.g., data packets flowing in and out and viruses running on internal devices). The gateway device 110 can be the FORTIgate device described below, implemented as a single device (see e.g., FIG. 6), as multiple cooperating devices, or as a virtual device. Additional embodiments of the gateway device 110 are shown below with respect to FIG. 2.

Similarly, the switch 120 automatically configures data ports with the access point 130. These links can be distinct from links shared between the switch 120 and the gateway device 110, including different link speeds and duplex capabilities. In operation, data can travel through a first LACP link (data line 101) between the gateway device 110 and the switch 120, and then be moved to a second LACP link (data line 102) between the switch 120 and the access point 130.

The access point 130 provides security and operational state information for itself and connected stations. The station 140 can be upload state information via Wi-Fi. The station 140 can be a mobile client, for instance, a smartphone, a tablet computer, or a smart appliance.

FIG. 2 is a more detailed illustration of the gateway device 110 of the system 100 of FIG. 1. The gateway device 110 includes a link aggregation module 210, a network communication module 220, a network policy module 230, and a firewall module 240, for example. Other network hardware can be similarly modified to include link aggregation modules for compatibility with the system 100.

In an embodiment, the network communication module 220 hosts a data exchange between the gateway device 110 and an outside device, such as the gateway device 110 of FIG. 1. In response to initiation or preparation of the data exchange, the link aggregation module 210 optimizes budling of the data lines for the exchange, using the techniques described herein.

More generally, the network policy module 230 can implement network policy from a gateway standpoint of the network. The firewall module 240 monitors network traffic and restricts certain network traffic. Various network policies and firework policies can be implemented for standard operations of the gateway device 110.

Returning to the link aggregation module 210, more detail is shown in FIG. 3. The link aggregation module 210 of this example includes a bundle detector module 310, a physical capabilities module 320, a downgrading module 330, a LACP (Link Aggregation Control Protocol) data exchange module 340 and a network communication module 350. The modules can be implemented in source code stored in non-transitory memory executed by a processor. Alternatively, the modules can be implemented in hardware with microcode. The modules can be singular or representative of functionality spread over multiple components.

The bundle detector module 310 receives aggregate port selection from user to bundle at least two individual data ports of the network device for single channel data transfer.

The physical capabilities module 320 determines lowest common denominators of physical capabilities (speed and duplex) of selected ports on the network device through an operating system.

The downgrading module 330 commits downgrading physical capabilities of at least one of the at least two data ports to match lowest common denominators of the at least two data ports.

The LACP data exchange module 340 conducts data exchanges over the at least two ports of the network device according to LACP. More generally, LACP is an IEEE protocol to control bundling of several physical links to form a single logical link. LACP allows the gateway device 110 to negotiate an automatic bundling of links by sending LACP packets to their peer, a directly-connected device that also implements LACP. There can be 1 to 8 bundled ports per channel, although other standards and futures standards may vary and still be within the scope of the present disclosure. This bundled data transfer can provide higher throughput.

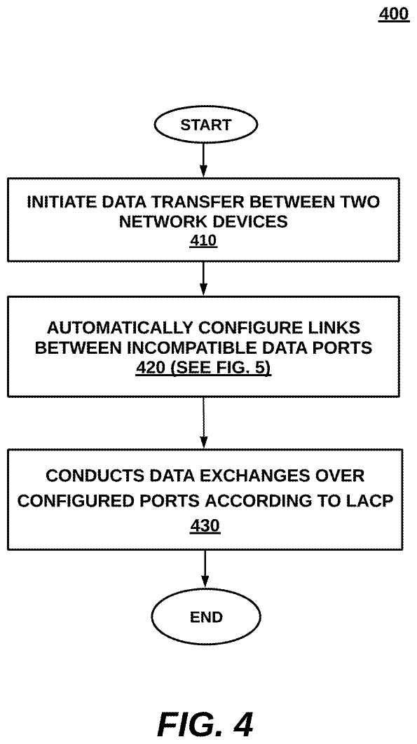

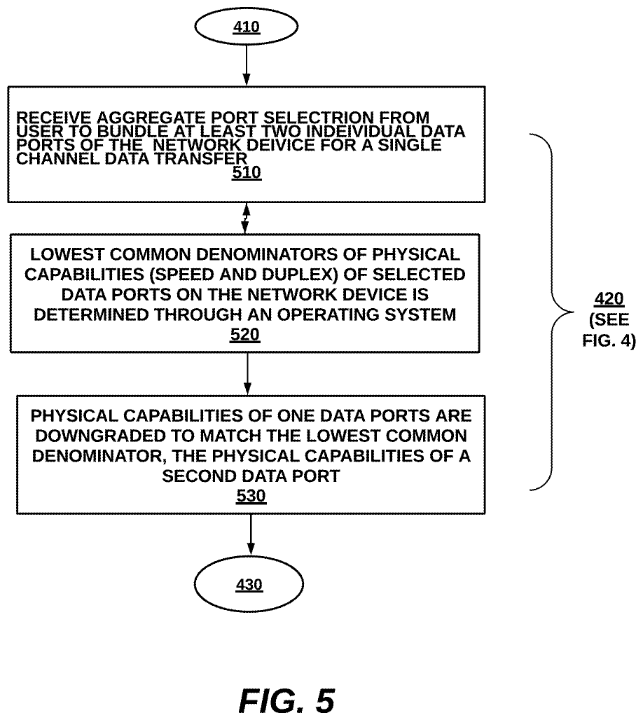

II. Methods for Automatic Link Aggregation for Incompatible Data Ports (FIGS. 4-5)

FIG. 4 is a high-level flow diagram illustrating a method for data transfers using LACP, according to one embodiment. The method 400 can be implemented, for example, by the system 100 of FIG. 1. The steps are merely representative groupings of functionality, as there can be more or fewer steps, and the steps can be performed in different orders. Many other variations of the method 400 are possible.

At step 410, a data transfer is initiated between two network devices. At step 420, links are automatically configured between incompatible data ports, as is described further in FIG. 5. At step 430, data exchanges are conducted over the at least two ports of the network device according to LACP.

Turning to FIG. 5, at step 510, an aggregate port selection is received from user to bundle at least two individual data ports of the network device for single channel data transfer.

At step 520, the lowest common denominators of physical capabilities (speed and duplex) of selected ports on the network device through an operating system is determined.

At step 530, physical capabilities of at least one of the at least two data ports are downgraded committed to match lowest common denominators of the at least two data ports.

III. Generic Computing Device (FIG. 6)

FIG. 6 is a block diagram illustrating an example computing device 600 for use in the system 100 of FIG. 1, according to one embodiment. The computing device 600 is implementable for each of the components of the system 100 (e.g., the gateway device 110, the switch 120, the access point 130 and the station 140). The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog and use any suitable protocol.

The memory 610 further comprises network applications 612 and an operating system 614. The network applications 612 can include a web browser, a mobile application, an application that uses networking, a remote application executing locally, a network protocol application, a network management application, a network routing application, or the like.

The operating system 614 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 620 can be a network processor (e.g., optimized for IEEE 802.11, IEEE 802.11AC or IEEE 802.11AX), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A network device on an enterprise network that connects with a plurality of peripheral network devices on the enterprise network for data transfers, for automatically configuring link aggregation of incompatible data ports, the network device comprising:
a processor;
a network interface communicatively coupled to the processor and to the enterprise network; and
a memory, storing source code executed by the processor and comprising:
a first module to receive an aggregate port selection from user to bundle at least two individual data ports of the network device for single channel data transfer;
a second module to determine lowest common denominators of physical capabilities (speed and duplex) of selected ports on the network device through an operating system;
a third module to commit downgrading physical capabilities of at least one of the at least two data ports to match lowest common denominators of the at least two data ports; and
a fourth module to conduct data exchanges over the at least two ports of the network device according to LACP (Link Aggregation Control Protocol), wherein configuration messages are sent to a destination device, compatible with LACP, to negotiate the data transfer including configuration of the at least two data ports.

2. The network device of claim 1, wherein the third module commits downgrading physical capabilities of at least one of the at least two data ports to match lowest common denominators of the at least two data ports by gaining access to session terminal and API call from OS to switching module in MAC card which controls physical port.

3. The network device of claim 1, wherein the second module determines lowest common denominators of physical capabilities, based on speed and duplex, of selected ports on the network device through an operating system.

4. The network device of claim 1, wherein a cloud vulnerability server provides a software as a service to the network device and a plurality of other subscribers associated with different enterprise networks.

5. The network device of claim 1, wherein the network device comprises a firewall device.

6. The network device of claim 1, wherein the network device comprises a Wi-Fi controller device.

7. A computer-implemented method in a network device on an enterprise network that connects with a plurality of peripheral network devices on the enterprise network for data transfers, for automatically configuring link aggregation of incompatible data ports, the method comprising the steps of:
receiving an aggregate port selection from user to bundle at least two individual data ports of the network device for single channel data transfer;
determining lowest common denominators of physical capabilities (speed and duplex) of selected ports on the network device through an operating system;
committing downgrading physical capabilities of at least one of the at least two data ports to match lowest common denominators of the at least two data ports; and
conducting data exchanges over the at least two ports of the network device according to LACP (Link Aggregation Control Protocol), wherein configuration messages are sent to a destination device, compatible with LACP, to negotiate the data transfer including configuration of the at least two data ports.

8. A non-transitory computer-readable media in a network device on an enterprise network that connects with a plurality of peripheral network devices on the enterprise network for data transfers, when executed by a processor, for automatically configuring link aggregation of incompatible data ports, the method comprising the steps of:
receiving an aggregate port selection from user to bundle at least two individual data ports of the network device for single channel data transfer;
determining lowest common denominators of physical capabilities (speed and duplex) of selected ports on the network device through an operating system;
committing downgrading physical capabilities of at least one of the at least two data ports to match lowest common denominators of the at least two data ports; and
conducting data exchanges over the at least two ports of the network device according to LACP (Link Aggregation Control Protocol), wherein configuration messages are sent to a destination device, compatible with LACP, to negotiate the data transfer including configuration of the at least two data ports.
